(19) United States
(12) Patent Application Publication
(10) Pub. No.: US 2023/0407188 A1
(43) Pub. Date: Dec. 21, 2023

(54) METHOD FOR REMOVING ASPHALTENES, RESINS AND HEAVY METALS FROM CRUDE OIL

(71) Applicant: ROCK SPRINGS ENERGY GROUP, LLC, SAN ANTONIO, TX (US)

(72) Inventor: VENKATA MANOHAR PALLA, HOUSTON, TX (US)

(21) Appl. No.: 18/211,868

(22) Filed: Jun. 20, 2023

Related U.S. Application Data
(60) Provisional application No. 63/353,765, filed on Jun. 20, 2022.

(51) Int. Cl. C10G 21/00; C10G 21/16; C10G 21/14; B01D 61/14; B01D 69/02; B01D 65/02

(52) U.S. Cl. CPC C10G 21/003; C10G 21/16; C10G 21/14; B01D 61/145; B01D 69/02; B01D 71/02; C10G 2300/206; B01D 2325/0283; B01D 2321/04; B01D 2321/168; B01D 65/02

(57) ABSTRACT

Presented is a method for using an ethyl acetate solvent to remove all or most of the asphaltenes, resins and heavy metals from crude oil. The oil is filtered to remove the precipitants and the permeate is then deasphalted oil, rich in ethyl acetate solvent. The ethyl acetate may be recovered by flashed solvent recovery system and recycled back. Filter elements are regenerated with toluene and recovered by a flashed solvent recovery system.

This application is based upon and claims priority from U.S. Provisional application Ser. No. 63/353,765, filed Jun. 20, 2022, which is incorporated herein by reference.

### BACKGROUND OF THE INVENTION

### Field of the Invention

Applicants' invention relates to a method for using ethyl acetate solvent to precipitate asphaltenes, resins and heavy metals from crude oil in single step.

### Background Information

Crude oils available on the open market today often contain significant amounts of metal-containing organic compounds. These crudes are, in comparison to those used in the past, of a higher average molecular weight. Despite the change in crude oil feedstocks, the products into which crude oils are made, e.g., gasoline, fuel oil, diesel, etc., remain substantially the same. Consequently, additional upgrading techniques are necessary to make optimum use of available crude oils.

Typical front-end refinery processing steps include a desalting step, which removes salt and other water-soluble compounds; an atmospheric pressure distillation step, which separates lower boiling hydrocarbon components and produces a heavy atmospheric residual oil (“HAR”); and a vacuum distillation step which produces a stream of middle boiling distillates and a heavy vacuum residual oil (“HVR”). Heavy oils are not, in a typical refinery economic scheme, products that are of themselves desirable end products. They typically must be converted into some other form before they become valuable. Residuals are complex mixtures containing four generic fractions: so-called “saturates,” “aromatics,” “polars,” and asphaltenes. The term “polars” is used synonymously with “resins” in heavy oil processing. Of the factors that adversely influence the quality of the heavy oils, the most noteworthy are the coke-forming tendency, metals content (particularly vanadium and nickel), nitrogen content and “asphaltene” content. Each of these factors typically becomes more of a problem with increasing molecular weight.

Residue contains detrimental quantities of metals, which are catalyst poisons, and asphaltenes, which are prone to form coke. Removal of asphaltenes and heavy metal hydrocarbons from the residual is required for the end product to be lubricating oil, wax or catalytic cracking of residual hydrocarbons to transportation fuels. Asphaltenes can be removed by various techniques like solvent deasphalting, vacuum distillation and membrane processing.

Conventionally, a solvent deasphalting (“SDA”) process is employed by an oil refinery for the purpose of extracting valuable components from a residual oil feedstock, which is a heavy hydrocarbon produced as a by-product of refining crude oil. The extracted components are fed back to the refinery wherein they are converted into valuable lighter fractions such as gasoline. Suitable residual oil feedstocks which may be used in a SDA process include, for example, atmospheric tower bottoms, vacuum tower bottoms, crude oil, topped crude oils, coal oil extract, shale oils, and oils recovered from tar sands.

Crude oil bottoms is generally referred to as such because it consists of a mixture of crude oil or lease condensate, water, and other substances that tends to concentrate at the bottom of containers. Generally, atmospheric distillation of crude oil is a process used for the separation of the different hydrocarbons present in the crude oil into useful fractions (sometimes referred to as basic products or cuts). The highest boiling point liquid condenses at the bottom of the column, while the lowest boiling point liquid condenses at the top of the column. Fractions having boiling points between the highest and lowest boiling points, condense between the top and the bottom of the column. The various fractions obtained from the distillation process are light, medium, and heavy naphtha, kerosene, diesel, and oil residue and they separate and migrate to different levels in a distillation column depending on the difference in volatility/boiling point ranges. Light gases (methane, ethane, propane and butane) pass out the top of the column, while naphtha and straight run gasoline is formed in the top trays. Kerosene, diesel, and atmospheric gas oils are formed in the middle of the column, and residue or fuel oils exit at the bottom of the column. Atmospheric bottoms is the heaviest of the distillation cuts out of an atmospheric distillation tower. It consists of all of the components of crude oil that have boiling points above about 650° F. (343° C.).

In a typical SDA process, is an extractive-precipitation process which selectively precipitates asphalt, resins and hydrocarbons on the basis of density and the invert solubility of the heavy hydrocarbons in liquefied light hydrocarbons. Propane is preferred over the other liquefied gases used in the milder “deep” deasphalting processes to prepare feedstocks for fuels processing, because considerably more asphalt and resins must be precipitated to prepare a deasphalted oil (“DAO”) which can be used for the manufacture of lube base stocks. Deasphalting is an extractive-precipitation process. The purpose of the process is the removal of asphaltenes, resins and metals from vacuum residua and very heavy vacuum gas oils. Although the process is primarily used to remove asphaltic materials from the feedstock, it also removes other undesirable materials such as sulfur, nitrogen, aromatics and metals. It also improves the color and viscosity index of the feedstock. Along with the beneficial changes, the wax content of the deasphalted oil increases.

Once the asphaltenes have been removed, the substantially asphaltene-free stream of DAO, resins and solvent is normally subjected to a solvent recovery system. The solvent recovery system of an SDA unit extracts a fraction of the solvent from the solvent rich DAO by boiling off the solvent, commonly using steam or hot oil from fired heaters. The vaporized solvent is then condensed and recycled back for use in the SDA unit. Often it becomes beneficial to separate a resin product from the DAO/resin product stream. This is normally done before the solvent is removed from the DAO. “Resins” as used herein, means resins that have been separated and obtained from a SDA unit. Resins are denser or heavier than deasphalted oil, but lighter than the asphaltenes. The resin product usually comprises more aromatic hydrocarbons (unsaturated hydrocarbons which have one or more planar six-carbon rings called benzene rings, to which hydrogen atoms are attached) with highly aliphatic substituted side chains, and can also comprise metals, such as nickel and vanadium. Major process variables for the deasphalting are the quality of feed stock, type of solvent, temperature, solvent to feedstock ratio, and pressure.

The deasphalting devices used in continuous deasphalting units consist of vertical towers containing slats, gratings, baffles or rotating discs and stators. Baffle towers, in many instances, have replaced the mixer-settlers used in the early deasphalting units.

Residuum oil supercritical extraction (“ROSE”) solvent deasphalting is a commercially available process. In the ROSE process, residue is mixed with selective solvent in a mixer and asphaltenes are separated in an extraction tower. Solvent extracts only the non-asphaltenic oil collected at the top of extraction tower and an asphaltene rich phase is collected at the bottom of the tower. Once the asphaltenes have been removed, the substantially asphaltene-free stream of DAO, resins and solvent is normally subjected to a solvent recovery system. The solvent recovery system of an SDA unit extracts a fraction of the solvent from the solvent rich DAO by boiling off the solvent, commonly using steam or hot oil from fired heaters. The vaporized solvent is then condensed and recycled back for use in the SDA unit.

In this process, designing of the extraction tower is very critical and design varies with different crude oils. Pilot plant testing should be performed on the residue to determine the size and design of the extraction tower. The most common solvent used in ROSE solvent deasphalting is propane. Since propane's boiling point is low (approximately −43.6° F.), the solvent deasphalting is designed for higher pressures. Energy cost is high for this process and is not economical for a smaller capacity unit. Conversely, zeolite adsorption has been found to be inefficient for the deasphalting of oil, leaving asphaltenes.

In conventional solvent deasphalting, different solvents such as: Pentane, Hexane, Acetone, and Heptane may be used. Crude oil bottoms are mixed with solvent to precipitate out the asphaltenes. Precipitated asphaltenes are removed by filtration. The permeate is rich in oil solvent and leaves behind asphaltenes on the filter paper. In the process, DAO solvent is evaporated in an inert medium.

After use of solvents Pentane, Hexane, Acetone, and Heptane the DAO looks black. Extracted fractions indicate that blackness in the Atmospheric bottoms is due to resins and asphaltenes. The problem is to remove both resins and asphaltenes from the crude oil bottoms, and it is beneficial to remove them together. The ROSE process (which uses Propane as deasphalting solvent) precipitates both Asphaltenes and Resins. However, propane solvent deasphalting requires high pressure system due to low boiling point of Propane and requires high solvent to feed ratio. High solvent to feed ration increases energy cost in recovery of the solvent.

### SUMMARY OF THE INVENTION

The solvent of the current invention can be worked with at low pressures, like hexane (boiling point of approximately 156° F. (69° C.)) and heptane (boiling point of approximately 208° F. (98° C.)) which are relatively high boiling points. But heptane and hexane cannot precipitate resins along with asphaltenes. Ethyl Acetate is used as a solvent to precipitate both asphaltenes and resins, but it was not known to be used in deasphalting system in removing heavy metals, asphaltenes and resins.

The ROSE process is a conventional method used to extract deasphalted oil from atmospheric or vacuum residues and other feedstocks. The ROSE process deasphalting operation is carried out in an extractor where the feed is placed in contact with a solvent that promotes precipitation of asphlatic fraction. Separation between asphaltic and oily fraction is accentuated by operating with a temperature gradient between top and bottom of the extractor. Liquefied gasses of light hydrocarbons and saturated light hydrocarbons, which are liquid at ambient temperature and atmospheric pressure, are used to precipitate the asphaltic fraction.

Common equipment used in the process are extraction towers containing slats, gratings, baffles or rotating discs and stators. Making this equipment specific for the process is critical and varies with different feedstocks. Testing is required to determine process conditions and sizing of the extraction towers in solvent deasphalting process.

Uinta Black waxes are thick crude oils with a higher paraffinic content than most crude oils found in North America. These waxy crudes are viscous and have a high pour point, becomes semi-solid at lower temperatures. The process for refining waxy crudes presents some challenges. Although black wax is well suited for making gasoline, wax, and diesel fuel, refining must occur close to the source, because waxy crudes solidify quickly.

High paraffin content waxy crudes, only certain refineries are setup to process waxy crude oils having a refining constraint at Salt Lake City. Total Refining capacity in Salt Lake City is around 185,500 bbl/day which is relatively small out of total refining capacity, only 88,000 bbl/day is waxy crude refining capacity. Hence there is requirement in refining the waxy crudes.

A 2500 BBLD crude topping may be used in refining to get products like naphtha, residue mineral spirits, odorless mineral spirits, diesel and paraffinic wax. However, before the de-oiling process, wax must be extracted—extracting paraffinic wax impurities like asphaltenes, resins, and heavy metals.

The present invention ethyl acetate solvent system will remove all or most of the three impurities in the atmospheric residue prior to the de-oiling system. Ethyl acetate and crude bottoms, at an approximate ratio of from 1:1 to 4:1, is mixed thoroughly at a temperature in the range of 80° F. to 130° F. which will precipitate out the asphaltenes, resins and heavy metals. The solution is filtered to remove the precipitants and the permeate then comprises deasphalted oil, rich in ethyl acetate solvent. The ethyl acetate may be recovered by flashed solvent recovery system and recycled back to be used again in the atmospheric residue prior to the de-oiling system. Filter elements are regenerated with toluene and recovered by a flashed solvent recovery system.

Approximately 93.5% of asphaltenes are removed by this ethyl acetate solvent system. The preferred solvent to feed ratio is less than the commercially available solvent deasphalting system. Due to less solvent to feed ratio would aid in saving energy costs in recovery of solvent.

A filtration system (an embodiment of which is illustrated shown in FIG. 2) may be used instead of an extraction system used in the ROSE deasphalting system.

The proposed system can be used for the current crude residues, as well as for any other crude residues, to remove asphaltenes, resins and heavy metal impurities.

The advantages of the system include that Ethyl Acetate solvent deasphalting with membrane filtration will work well with low solvent to feed ratio, which aids in saving energy costs as compared to the ROSE process. A simple flashed solvent recovery system may be used instead of a supercritical solvent recovery system. A membrane filtration system may be used (an embodiment of which is illustrated in FIG. 3) instead of very complex extraction towers in removing the impurities. Conventional propane solvent deasphalting systems work at high pressure, whereas the ethyl acetate solvent system works at ambient temperature and atmospheric pressures. The proposed ethyl acetate solvent deasphalting system can be used for different crude bottoms with high impurities. And, ethyl acetate solvent precipitates asphaltenes, resins and heavy metals in single step.

Thus, the method for removing asphaltenes, resins, and heavy metals from crude oil, comprises adding a volume of crude oil into a mixing chamber. A volume of ethyl acetate is also added into the mixing chamber at an approximate ratio to the volume of crude oil in a range from 1:1 to 4:1. The crude oil and ethyl acetate form a solution that is mixed until the solution is separated into precipitants and a permeate. The precipitants comprise asphaltenes, resins, heavy metals, or a combination of asphaltenes, resins, and heavy metals. The permeate comprises the deasphalted oil and the ethyl acetate. The precipitants are separated from the permeate using a filter, wherein said filter has pores in the size in the range of 5 nm to 10 nm. The ethyl acetate is then recovered or regenerated from the permeate leaving deasphalted oil. The method may be run with the crude oil/ethyl acetate solution at ambient temperature. Or, the crude oil/ethyl acetate solution may be heated to a temperature in the range of 80° F. to 130° F.

As a cost saving measure, the method for removing asphaltenes, resins, and heavy metals from crude oil may be done in additional iterations using the recovered ethyl acetate multiple times.

It is anticipated, but not required that the method for removing asphaltenes, resins, and heavy metals from crude oil, may employ a filter or filters that have a ceramic membrane which can handle maximum pressure 10 bar and maximum temperature of 450° F. It is helpful if such filters are capable of being backwashed with a solvent (such as toluene), allowing the filters to be reused in additional iterations of the method for removing asphaltenes, resins, and heavy metals from crude oil.

### BRIEF DESCRIPTION OF THE DRAWINGS

FIG. 1 is a process flow diagram illustrating a method for using an ethyl acetate solvent for deasphalting of crude oil.

FIG. 2 is a flow chart illustrating a proposed ethyl acetate solvent deasphalting of atmospheric bottoms of Uinta Black waxy crude oil.

FIG. 3 is a flow chart illustrating an embodiment of the filtration system.

FIG. 4 illustrates an embodiment of an ultrafiltration membrane module.

FIG. 5 is a table of a saturates, aromatic, resin and asphaltenes (“SARA”) analysis report for black waxy Uinta crude oil.

FIG. 6 is a table of a SARA analysis report for atmospheric crude oil bottoms.

FIG. 7 is a table illustrating the results of a SARA analysis for both DAO and precipitant.

### DETAILED DESCRIPTION OF THE PREFERRED EMBODIMENT

| Ref. | Element |
|---|---|
| A | Ethyl Acetate Regeneration System |
| B | Toluene Regeneration System |
| 10 | Crude Oil |
| 12 | Crude Feed |
| 14 | Crude Feed Pump |
| 16 | Crude Feed Preheater |
| 18 | Desalter |
| 20 | Crude Furnace Heater |
| 22 | Steam |
| 24 | Atmosphere Crude Tower |
| 26 | Residue Mineral Spirits |
| 28 | Odorless Mineral Spirts |
| 30 | Kerosene |
| 32 | Diesel |
| 34 | Crude Bottoms |
| 36 | Crude Bottoms Pump |
| 38 | Mixer/Precipitator |
| 40 | Reflux Drum |
| 42 | Naphtha |
| 44 | Ethyl Acetate Makeup |
| 46 | Ethyl Acetate |
| 48 | Filtration System |
| 50 | EARS Heater |
| 52 | EARS Flash Drum |
| 54 | EARS Tower |
| 56 | Deasphalted Oil |
| 58 | Ethyl Acetate Reflux Cooler |
| 60 | Ethyl Acetate Reflux Drum |
| 62 | Ethyl Acetate Pump |
| 70 | Toluene Reflux Cooler |
| 72 | Toluene Reflux Drum |
| 74 | Toluene Pump |
| 76 | Precipitated Impurities |
| 78 | Toluene |
| 100 | Filter |
| 102 | Filter Membrane |
| 104 | Filtrate |
| 106 | Concentrate |
| 108 | Plugged Passageway |
| 110A | First End Slots |
| 110B | Second End Slots |
| 112 | Filter First End |
| 114 | Filter Second End |

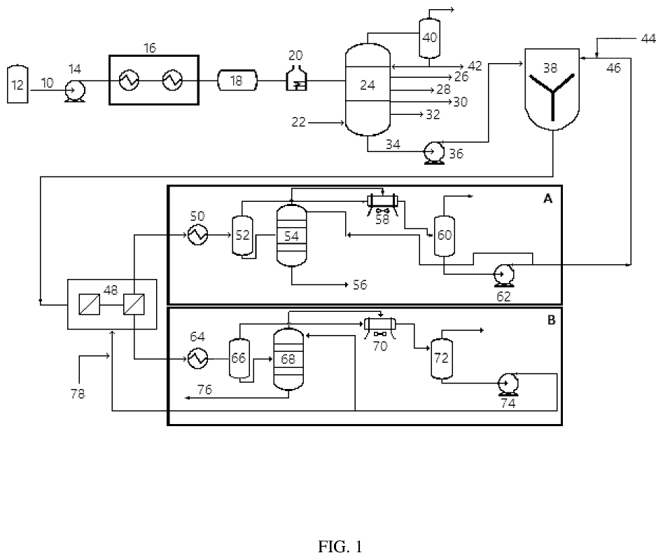

Referring to the figures, FIG. 1. illustrates a process flow diagram of a method for removing asphaltenes, resins and heavy metals from crude oil.

Crude oil 10 is pumped from a storage tank 12 into the system using crude feed pump 14. The crude oil 10 is preheated with a crude feed preheater 16. The temperature of the crude oil 10 may be controlled and set to a desired temperature range required for desalting by a cross exchanger 18. A cross-flow heat exchanger 18 is mainly composed of a cooling core (not shown) and a fan (not shown). The crude oil 10 to be warmed flows through the core channels (not shown) and the fan (not shown) moves air, or other temperature equalizing fluid, through the cross exchanger 18 in order to optimize and equalize the temperature of the crude oil 10.

The crude oil 10 is desalted in electrical desalter 18 where any salts in the crude oil 10 will be removed. As an initial step, water is mixed with the heated crude oil 10. During mixing, salt content in the crude oil 10 is washed with the water and a water/oil emulsion is formed. The salt is dissolved in the water in the crude oil 10, not in the crude oil itself. The emulsion then enters the desalter 18 where it is subject to the action of an intense electric field—often in the range of 16,000 to 30,000 volts AC. The high voltage provides the coalescing force and accelerates separation of the water laden with salt in the oil 10. As coalescence proceeds, water droplets grow large enough to overcome the viscosity of the crude oil 10 and settle to the bottom due to gravity. Cleaned crude oil 10, freed of the salt, rises to the surface and is separated from the salt contaminants. Efficiency of a desalter 18 is usually 95% in a single stage and up to 99% in two stages.

The preheated crude oil 10 is then transported to a furnace heater 20 where it is heated further up to a desired temperature. The crude oil 10 is then fed to the atmospheric crude tower 24. The atmospheric crude tower 24 provides distillation of the crude oil 10. In atmospheric distillation, the desalted crude oil 10 is heated to about 750° F. then fed to a vertical distillation column (not shown) under pressure. The crude 10 vaporizes and separates into various fractions by condensing on 30-50 fractionation trays, each corresponding to a different condensation temperature. Lighter fractions condense and collect toward the top of the column (not shown). Vapors will be condensed and collected in a reflux drum 40.

Condensed vapors will be separated to oil 10 and water. Oil 10 will be the naphtha product 42 which is both refluxed to crude oil tower 24 and collected as naphtha product 42 to naphtha storage tank (not shown) via a pump (not shown).

Residue Mineral Spirits (“RMS”) product 26 will be drawn as a side draw from the column 24 will be cooled with crude 10-RMS 26 cross exchanger (not shown) before pumped to storage tank (not shown) via RMS product pump (not shown).

Odorless Mineral Spirts (“OMS”) product 28 is drawn as a side draw from the column 24 will be cooled in crude 10-OMS 28 cross exchanger (not shown) before pumping to storage tank (not shown) via OMS product pump (not shown).

Kerosene product 30 is drawn as a side draw from the column 24 will be cooled in crude 10-kerosene 30 cross exchanger (not shown) before pumping to storage tank (not shown) via kerosene product pump (not shown).

Diesel product 32 will be drawn as a side draw from the column 24 will be cooled with crude 10-diesel 32 cross exchanger (not shown) before pumped to storage tank (not shown) via diesel product pump (not shown).

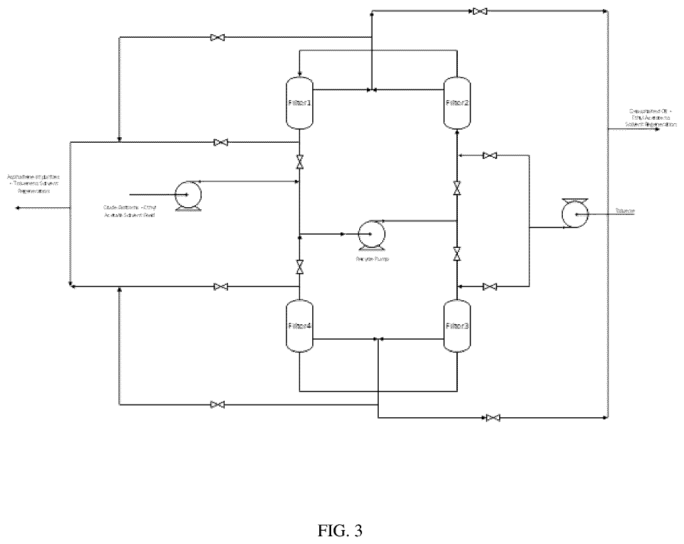

The filtration system 48 acts to de-asphalt the crude oil 10 via solvent extraction. Crude bottoms 34 from the atmosphere crude tower 24 are pumped using a crude bottoms pump 36 to the deasphalting system 48. Bottoms 34 are mixed with ethyl acetate (solvent) 46 in mixer settler 38 and then passed through cooler 58 to cool the mixture where the asphaltene precipitation will take place. The precipitated asphaltenes will be filtered in filtration system 48 (further shown in FIG. 3) to separate the precipitant asphaltenes and impurities from the deasphalted oil 10 along with solvent 46. The crude oil 10 is now deasphalted oil 56, and along with solvent 46 will be the filtrate coming out of the filtration system 48.

The ethyl acetate regeneration system (“EARS”) is illustrated in the figure as “A”. Ethyl acetate solvent 46 will be recovered in ethyl acetate regeneration tower 54. Filtrate is heated in the solvent steam evaporator 50, vapor and liquid is separated in flash drum 52. Liquid from the flash drum 53 which has both ethyl acetate solvent 46 and DAO 56 will fed to ethyl acetate regeneration tower 54, where ethyl acetate solvent 46 will be recovered at the overhead of the column 54. The vapor from the flash drum 52 and ethyl acetate regeneration tower 54 overhead vapor will be condensed in ethyl acetate reflux cooler 58 and collected in ethyl acetate reflux drum 60. Ethyl acetate solvent 46 will be recycled back to the mixer settler 38 before that it is heated back to desired temperature with cross exchangers 50. Makeup solvent 44 due to any loss will be fed through via makeup pump 62. Bottoms DAO 56 from ethyl acetate regeneration tower 54 is pumped via DAO storage pump 62 to the DAO storage tank 60.

The toluene regeneration system (“TRS”) is illustrated in the figure as “B”. Regeneration/cleaning of the filter membrane, or element, 100 in filtration system “B” will be done by using toluene solvent 78. Cleaning/regeneration of filter elements 100 needs to be performed once the filter elements 100 are clogged. Toluene solvent 78 will be recovered in toluene regeneration tower 68. Filtrate will be heated in the TRS heater 64, vapor and liquid will be separated in flash drum, or toluene reflux drum, 72. Liquid from the flash drum 72, which has both toluene and impurities 76, will be fed to toluene regeneration tower 68, where toluene solvent 78 will be recovered at the overhead of the column. The vapor from the flash drum 72 and toluene regeneration tower 68 is condensed in toluene reflux cooler 70 and collected in toluene reflux drum 72. The toluene reflux pump 74 will be used to recycle back toluene 78 for cleaning the filter elements 100. Bottoms will be rich in asphaltenes, while resins will be waste and needed to be discarded or can be used as another product.

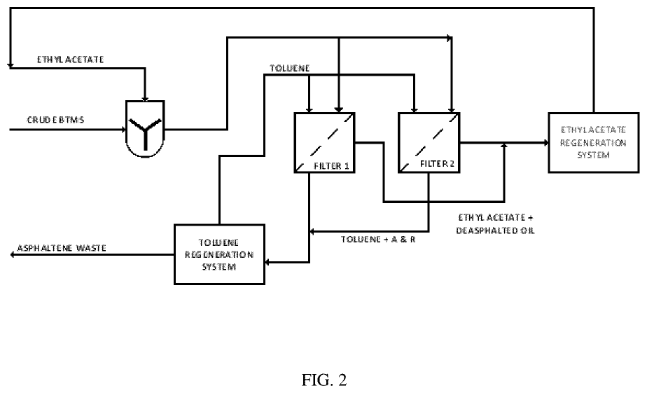

FIG. 2 illustrates a filtration system which separates the asphaltenes, resins and heavy metals from the paraffin bottoms effectively and produces paraffin of the purity required. The filters must be capable of being backwashed and then be reused and have a multi-year service life element which can handle the pressure and temperature for the filtration system. Ceramic membranes may be used to remove asphaltene and Ni, V metals. The current invention uses filters to remove asphaltenes. It is believed that ceramic filter element filtration with different solvents can remove approximately 94.4 wt. % asphaltenes and other heavy metals. The economics for the filter and solvent recovery process for asphaltenes is better than the current ROSE de-asphalting process, primarily because of needing less solvent to remove the asphaltenes. Conventionally, the solvents hexane, pentane and heptane have been used, but they only precipitate asphaltenes. The current invention uses ethyl acetate solvent, which will precipitate asphaltenes, resins and heavy metals. The figures illustrate an embodiment for removing impurities like asphaltenes, resins and heavy metals from crude oil bottoms.

First filter will be a part of the filtering cycle, while the second filter is in the regeneration cycle. This system is very flexible as multiple filters (first and second) may be added in series for larger capacity units. Filter elements use ceramic membranes which can handle maximum pressure 10 bar and maximum temperature of 450 F. Pore size of the filter elements is in the range of 5 nm to 10 nm. This much smaller than the average particle size of the asphaltenes, resins and heavy metals when they are initially precipitated, which is expected to be in a range of about 1000 nm to 1200 nm. Toluene is used for cleaning/regenerating the filter membranes. Toluene will also reduce the size of the particles. Obviously, the size of the particles cannot be reduced so much that the filters are unable to catch the particles. Generally though, once the asphaltenes, resins and heavy metal particles are dissolved in toluene, the resulting average particle size is reduced to an expected range of about 10 nm to 20 nm. Thus, when initially precipitated, the average particle size is expected to be greater than 1000 nm, which is much greater than pore size of the membranes, and when dissolved with Toluene the particle size is reduced to about 10 nm to 20 nm but still large enough such that the ceramic membrane is still able to filter out the asphaltene, resin and heavy metal particles.

FIG. 3 illustrates a proposed filtration system. In one embodiment, filters 1 and 2 are in series and filters 3 and 4 are in series. Filters 1 and 2 are in the filtration cycle, while filters 3 and 4 are in the regeneration cycle. In the filtration cycle, feed, ethyl acetate, and crude bottoms along with recycled concentrate will be fed into filter 2. Precipitated asphaltenes and other impurities are filtered, leaving a filtrate of DAO and ethyl acetate. Unfiltered concentrate is fed into filter 1, which is in series with filter 2 where further filtration would take place to remove impurities. Precipitates with impurities, asphaltenes, resins and heavy hydrocarbons, are retained on the filter membranes. This process is continued until filter elements 1 and 2 are clogged making further filtration inefficient. Ethyl acetate from the filtrate is recovered in a solvent recovery system leaving behind the deasphalted oil. The number of filter elements in series may be increased based on the capacity of the filtration system. When filters 1 and 2 become clogged, filters 3 and 4 may be put into the filtration cycle. While filters 3 and 4 are in use in the filtration cycle filters, filters 1 and 2 may be regenerated by cleaning them with toluene and readied to again be used in the filtration cycle. The toluene used for cleaning the filter may be recovered in the solvent recovery system.

The system solvent deasphalting and filtration system can be used for processing various types of heavy crude oils and crude oil bottoms. If this system is used on heavy crude oils, the advantages can include:
1. Downstream equipment is protected from clogging due to the asphaltene impurities;
2. Handling of the fluid will be easier; and
3. Maintaining the crude oil at a high temperature is not required for the crude oil to flow helping to reduce energy costs.

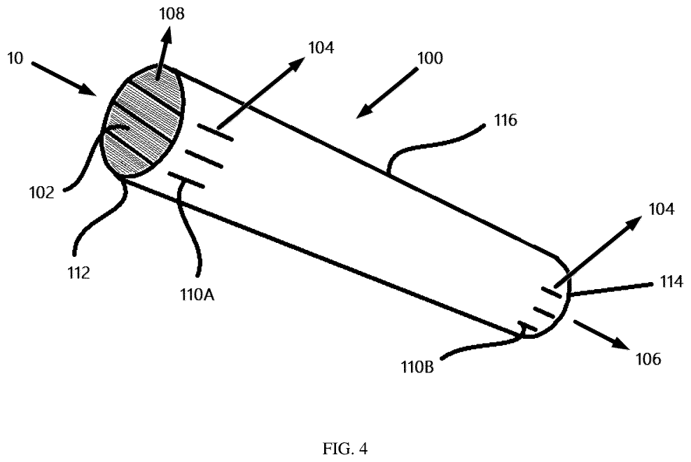

FIG. 4 illustrates an embodiment of an ultrafiltration (“UF”) membrane module, or filter, 100 that may be used in the filtration system B. The UF membrane module 100 is a large diameter, monolith membrane module with permeate conduits. The silica and titania UF membranes 102 have low fouling characteristics in ultrafiltration of heavy oils 10. The silica membrane 102 has a pore size of about 5 nm and the titania membrane about 10 nm. The starting point for application of the UF membranes 102 is a two-layer microfiltration (“MF”) membrane coating on a SiC support. Individual MF layers 102 comprise (a) a first “mixed oxide” MF membrane layer (pore size approx. 0.5 μm), and (b) an α-alumina MF membrane layer (pore size approx. 0.1 μm).

The UF membrane module 100 has an outer shell 116, that is anticipated to generally be in a tubular shape, but the outer circumference can be virtually any shape combined with a hollow interior. The module's 100 hollow interior is filled (to some extent) with a multiplicity of MF membrane layers 102. Feed (feed, ethyl acetate, and crude bottoms along with recycled concentrate) 10 is pumped into a first end 112 of the module 100 where the passageways are created with the silica membrane 102. The feed 10 flows through the pores in the membrane 102 and precipitated asphaltenes and other impurities are caught, leaving a filtrate 104 of DAO and ethyl acetate 46. The filtrate 104 flows through the pores in the membranes 102 toward the second end 114 out the of the module 100 through first slots 110A and second slots 110B. The second slots 110B may be plugged at the second end 114. Crude concentrate 106 exists the filter second end 114. Plugged passages 108 isolate the filtrate 106.

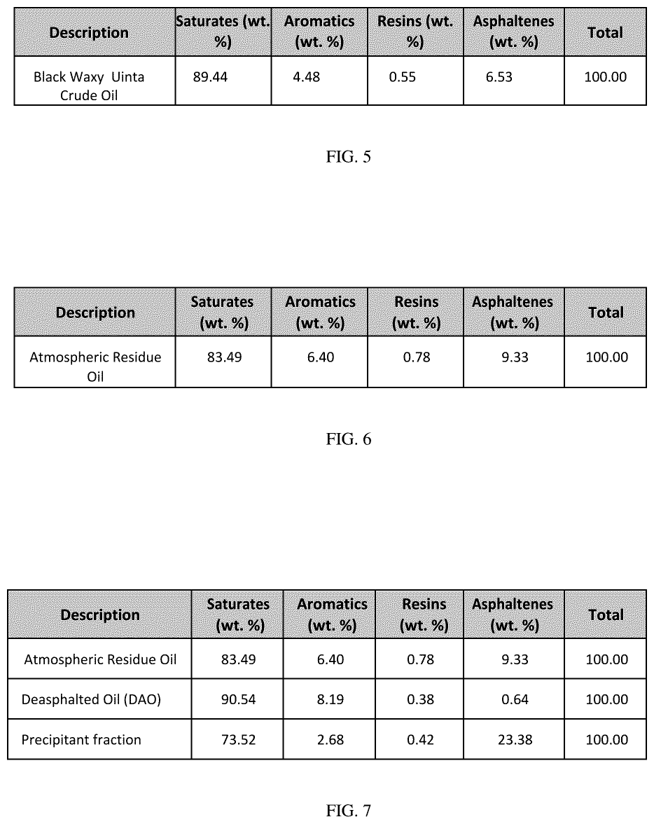

FIG. 5 is a table illustrating the results of a SARA analysis for black waxy Uinta crude oil determining the saturates, aromatic, resin and asphaltenes. A SARA analysis first step is to precipitate asphaltene, resin and heavy metal particles by mixing feed with solvent and filter the solution to recover the precipitate particles. The asphaltenes and resins are shown precipitated with ethyl acetate solvent and the solution filtered to remove resins and asphaltenes. A filter separator is used to remove the asphaltenes and resins. Filter media can be regenerated/cleaned by Toluene as asphaltenes, and resins are soluble in toluene.

The wax content in the Crude oil content which was high in paraffinic content (62 wt. % wax) and needs to be extracted. Extraction of wax, impurities like Asphaltenes, resins and aromatics are to be removed from the crude oil. All the paraffins, asphaltenes, aromatics and resins end up in atmospheric crude oil bottoms. Crude oil atmospheric crude distillation is performed in order to extract light hydrocarbon fractions leaving behind the atmospheric residue. Atmospheric residue was used as feed stock for deasphalting.

FIG. 6 is a table illustrating the results of a SARA analysis for atmospheric residue bottoms to determine the saturates, aromatic, resin and asphaltenes. Wax content was found to have 88.3 wt. % wax.

FIG. 7 is a table illustrating the results of a SARA analysis for both DAO and precipitant. Crude bottoms were mixed with Ethyl acetate in 1:4 ratio to precipitate both asphaltenes and resins. The solution is heated and mixed thoroughly on a stirring hot plate for proper precipitation of asphaltenes and resins. Precipitated asphaltenes in the solution were vacuum filtered with 0.4 μm fritted Buchner flask. Permeate collected after filtration is deasphalted oil with ethyl acetate. Collected permeate DAO heated to evaporate ethyl acetate leaving behind deasphalted oil. Raffinate unfiltered precipitate is collected by mixing with toluene. Raffinate collected after filtration was heated to evaporate toluene to leave behind the precipitant.

SARA analysis for both DAO and precipitant was performed. Asphaltenes present in atmospheric residue was decreased from 9.33 wt. % to 0.64 wt. %, resins from 0.78 wt. % to 0.64 wt. %. The precipitant fraction has high asphaltene content indicating the asphaltenes are precipitated with ethyl Acetate solvent with 23.4 wt. % shown in table 3.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

Unless otherwise specifically noted, the elements and articles depicted in the drawings are not necessarily drawn to scale, but they are illustrative of the described implementations and are intended to disclose the elements and articles illustrated as part of the specification, and the drawings further indicate relative size, angles, shapes, arrangement, placement, and like information to one of ordinary skill in the art regarding the elements and articles in the drawing.

Throughout this disclosure, a hyphenated form of a reference numeral refers to a specific instance of an element and the un-hyphenated form of the reference numeral refers to the element generically or collectively. Thus for example, widget 12-1 would refer to a specific widget of a widget class 12, while the class of widgets may be referred to collectively as widgets 12 and any one of which may be referred to generically as a widget 12.

As used herein, “removably attached,” “removably attachable,” or “removable” mean that a first object that is coupled to a second object may be decoupled from the second object, or taken away from an attached position relative to the second object, using some force or movement. “Removably attached,” “removably attachable,” or “removable” further mean that if the first object is not coupled with the second object, the first object may be coupled to the second object or returned to the attached position, using some force or movement. Both the decoupling and the coupling may be accomplished without damaging either the first object or the second object.

When the terms “substantially,” “approximately,” “about,” or “generally” are used herein to modify a numeric value, range of numeric values, or list numeric values, the term modifies each of the numerals. Unless otherwise indicated, all numbers expressing quantities, units, percentages, and the like used in the present specification and associated claims are to be understood as being modified in all instances by the terms “approximately,” “about,” and “generally.” As used herein, the term “approximately” encompasses +/−5 of each numerical value. For example, if the numerical value is “approximately 80,” then it can be 80+/−5, equivalent to 75 to 85. As used herein, the term “about” encompasses +/−10 of each numerical value. For example, if the numerical value is “about 80,” then it can be 80+/−10, equivalent to 70 to 90. As used herein, the term “generally” encompasses +/−15 of each numerical value. For example, if the numerical value is “about 80,” then it can be 80%+/−15, equivalent to 65 to 95. Accordingly, unless indicated to the contrary, the numerical parameters (regardless of the units) set forth in the following specification and attached claims are approximations that may vary depending upon the desired properties sought to be obtained by the exemplary embodiments described herein. In some ranges, it is possible that some of the lower limits (as modified) may be greater than some of the upper limits (as modified), but one skilled in the art will recognize that the selected subset will require the selection of an upper limit in excess of the selected lower limit.

At the very least, and not limiting the application of the doctrine of equivalents to the scope of the claim, each numerical parameter should at least be construed in light of the number of reported significant digits and by applying ordinary rounding techniques.

The terms “inhibiting” or “reducing” or any variation of these terms refer to any measurable decrease, or complete inhibition, of a desired result. The terms “promote” or “increase” or any variation of these terms includes any measurable increase, or completion, of a desired result.

The term “effective,” as that term is used in the specification and/or claims, means adequate to accomplish a desired, expected, or intended result.

The terms “a” or “an” when used in conjunction with the term “comprising” in the claims and/or the specification may mean “one,” but it is also consistent with the meaning of “one or more,” “at least one,” and “one or more than one.”

The term “each” refers to each member of a set, or each member of a subset of a set.

The terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In interpreting the claims appended hereto, it is not intended that any of the appended claims or claim elements invoke 35 U.S.C. 112(f) unless the words “means for” or “step for” are explicitly used in the particular claim.

It should be understood that, although exemplary embodiments are illustrated in the figures and description, the principles of the present disclosure may be implemented using any number of techniques, whether currently known or not. The present disclosure should in no way be limited to the exemplary implementations and techniques illustrated in the drawings and description herein. Thus, although the invention has been described with reference to specific embodiments, this description is not meant to be construed in a limited sense. Various embodiments may include some, none, or all of the enumerated advantages. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. Modifications, additions, or omissions may be made to the systems, apparatuses, and methods described herein without departing from the scope of the disclosure. For example, the operations of the systems and apparatuses disclosed herein may be performed by more, fewer, or other components in the methods described may include more, fewer, or other steps. Additionally, steps may be performed in any suitable order.

What is claimed:

1. A method for removing asphaltenes, resins, and heavy metals from crude oil, comprising:
adding a volume of crude oil into a mixing chamber;
adding a volume of ethyl acetate into said mixing chamber, wherein said volume of ethyl acetate is at an approximate ratio to said volume of crude oil in a range from 1:1 to 4:1 to form a solution;
mixing said solution until said solution is separated into precipitants and a permeate, wherein said precipitants comprise asphaltenes, resins, heavy metals, or a combination of asphaltenes, resins, and heavy metals, and wherein said permeate comprises deasphalted oil and said ethyl acetate;
separating said precipitants from said permeate using a filter, wherein said filter has pores in the size in the range of 5 nm to 10 nm; and
regenerating ethyl acetate from said permeate leaving deasphalted oil.

2. The method of claim 1, wherein said solution is at ambient temperature.

3. The method of claim 1, further comprising heating said solution to a temperature in the range of 80° F. to 130° F.

4. The method of claim 1, further comprising using said recovered ethyl acetate in additional iterations of the method of claim 1.

5. The method of claim 1, wherein said filter uses a ceramic membrane which can handle maximum pressure 10 bar and maximum temperature of 450° F.

6. The method of claim 5, wherein said filter is capable of being backwashed with a solvent and then said filter may be reused in additional iterations of the method of claim 1.

7. The method of claim 6, wherein said solvent is toluene.

8. The method of claim 7, wherein there are multiple of said filters.

9. The method of claim 8, wherein said filters comprise a first filter used in said separating step, and a secon filter used in said regenerating step.

10. The method of claim 3, wherein said filter is capable of being backwashed with a solvent and then said filter may be reused in additional iterations of the method of claim 1.

11. The method of claim 10, wherein said solvent is toluene.

12. The method of claim 11, wherein there are multiple of said filters.

13. The method of claim 12, wherein said filters comprise a first filter used in said separating step, and a second filter used in said regenerating step.
